(19) United States
(12) Patent Application Publication
(10) Pub. No.: US 2026/0272042 A1
(43) Pub. Date: Sep. 17, 2026

(54) An Aerosol Generation Device

(71) Applicant: JT International SA, Geneva (CH)

(72) Inventor: Broderick Coburn, Geneva (CH)

(73) Assignee: JT International SA, Geneva (CH)

(21) Appl. No.: 19/480,237

(22) PCT Filed: May 8, 2024
(86) PCT No.: PCT/EP2024/062729

§ 371 Date: Oct. 30, 2025

(30) Foreign Application Priority Data
May 11, 2023 (EP) 23172729.8

(51) Int. Cl. A24F 40/53; A24F 40/65

(52) U.S. Cl. CPC A24F 40/53; A24F 40/65

(57) ABSTRACT

There is provided an aerosol generation device for releasably retaining a battery cell. The device may include an identification module and a controller. The identification module may be configured to obtain identification information of said battery cell when releasably retained in the device. The controller may be configured to control a function of the aerosol generation device based on the received identification information. The identification module may use a wireless communication protocol.

The present disclosure relates to an aerosol generation device, a system comprising an aerosol generation device and a battery, a battery for an aerosol generation device and a method of using an aerosol generation device.

### BACKGROUND

Various aerosol generation devices and systems are available that heat aerosol precursor material to release aerosol/vapour for inhalation, rather than relying on burning the material. These devices are portable, and a user may use the device multiple times with different consumables on a single charge.

Consumer electronics is one of the fastest-growing industries. Billions of electronic items are made, sold and disposed of annually, leaving significant impacts on the planet from shortening product lifespans, rising energy consumption, lack of adequate waste management, wasteful design, etc. Rapid advancements in technology, falling prices and consumer appetite for better products and personal electronics has resulted in WEEE (waste electrical and electronic recycling) becoming one of the fastest-growing waste streams in the EU and globally. In particular, batteries in WEEE and other applications, such as electric vehicles, contributed a large impact throughout their life cycle.

One aspect to improve the sustainability of batteries throughout their lifecycle is to facilitate the recycling and repurposing of batteries at their end-of-life. To achieve this the batteries in WEEE and other products should be easily removable and replaceable, allowing isolation of the battery from the device to facilitate recycling, improve higher collection rates allowing the valuable materials contained in batteries to be recovered and brought back into the economy. In addition, the replaceability potential allows increasing the span of products with failing or low performing/degraded batteries. If a non-genuine battery is installed, the replacement battery might be poorly designed or manufactured, a previously used battery, a damaged battery, and/or an incorrectly specified battery for the aerosol generation device.

Any of the above could lead to insufficient battery capacity, improper fit, or performance issues. Using non-genuine batteries might also result in unexpected behavior after installation or while charging.

It is the object of the invention to overcome at least one of the above referenced problems, or to provide an alternative solution.

### SUMMARY

According to the present disclosure there is provided an aerosol generation device for releasably retaining a battery, the device comprising: an identification module configured to obtain identification information of said battery when releasably retained in the device; and a controller configured to control a function of the aerosol generation device based on the received identification information, wherein the identification module operates using a wireless communication protocol, wherein the identification module is configured to scan for identification information from said battery in the event of a loss of electrical power being detected.

The aerosol generation device improves the safety of the device as it ensures that replacement batteries must be authorized for use with the device. Safety could be impacted if the aerosol generation device heats an aerosol generation consumable incorrectly, or sensorial performance may be impacted. In other words, batteries that are not designed or suitable for use with the aerosol generation device will be prevented from use with the aerosol generation device. This improves the safety of the device and may also lead to the avoidance of a poor sensory experience for the user, which may be caused by too much or too little aerosol being generated due to an incorrect battery being installed. The aerosol generation device ensures device performance is achieved as intended. For example: number of user sessions from a single charge is maintained, related to battery capacity; the aerosol production profile is maintained, related to voltage, current and power output.

Further, the identification check ensures that the device can operate safely, for example: the battery has appropriate measures for impact resistance; has flame retardant materials; fits the device as intended and will not apply mechanical forces to the battery or be loose in the device; does not expose the user to dangers during the installation process such as an exposed battery or risk of short-circuit potentially leading to thermal runaway.

Using a wireless communication protocol means that potentially unsafe wired connections between an inauthentic battery and the aerosol generation device would be avoided. Further, the wireless communication protocol increases the ease of use for the user. It may also obviate the need for the aerosol generation device to be directly connected to a computer or similar when this identification check is performed.

Scanning for identification information from said battery in the event of a loss of electrical power being detected provides benefits. That is to say that the authentication check could be done after a previous battery is removed (which would result in a power loss), and the identification module would perform the identity check of any new battery. The identification check may also occur after a battery has lost all of the electric charge. As such, when the battery has been at least partially charged, the identification check will confirm that it is still a suitable battery for use with the aerosol generation device.

The identification module may be configured to receive the identification information from said battery. That is to say that the battery may include an identification tag comprising the identification of the battery and the identification module is configured to obtain the identification information from the battery. Obtaining the identification information from the battery leads to efficiencies as it reduces the likelihood of the information being distorted in transmission.

In one example, the identification module comprises a radio frequency identification (RFID) module. RFID modules are relatively inexpensive and may be used to provide power to an RFID tag of the battery that includes the identification information. As such, the identification tag of the battery may be passive and not include an independent power source.

In one example, the radio-frequency identification module comprises a Near Field Communication (NFC) module. NFC modules are efficient and work extremely well over the short distances.

In one example, the controlled function comprises providing electrical power to a main circuit board of the aerosol generation device. That is to say that if an unsuitable battery is installed in the aerosol generation device, then power would not be supplied to the main circuit board. As such, safety of the device would be improved as only the correct amount of electric power would be supplied to the main circuit board.

In one example, the aerosol generation device comprises a memory configured to store identification information of one or more authenticated batteries, wherein in use, the controller is configured to determine if the received identification information matches identification information of an authenticated battery. In this way, the aerosol generation device could perform the battery authentication locally and so could operate even when it is not possible to communicate with an additional device.

In one example, the device comprises a communication module configured to receive identification information of one or more authenticated batteries. In this manner, the aerosol generation device could be provided with an updated list of aerosol generation devices on occasion.

The identification information may include information on a characteristic of said battery and the controller is configured to provide a power output level dependent on the characteristic. In this case, the aerosol generation device may be able to detect that the battery that has been installed has a lower power rating and adjust the function of the aerosol generation device to still provide a satisfactory user experience (for example by increasing the amount of time that a heater is on for).

In one example, there is provided a system comprising: the aerosol generation device as described above; and a battery releasably retained in the aerosol generation device.

The battery may comprise an identification tag, wherein the identification module is configured to be substantially aligned with the identification tag, in use, to obtain identification information from the identification tag. Aligning the identification tag and the module improves the likelihood of good data transfer from the identification tag to the identification module.

In one example, the battery is an asymmetrical shape configured to be releasably received in a corresponding matching asymmetrical recess in the aerosol generation device. Providing this shape of battery would prevent batteries with standard shapes working with the aerosol generation device and hence provide an extra layer of protection to prevent unauthorised batteries from being used with the aerosol generation device.

In one example, there is provided an aerosol generation device battery comprising: an identification tag comprising identification information of the aerosol generation device battery, wherein the battery is configured to be releasably received in an aerosol generation device and provide identification information to the aerosol generation device using a wireless communications protocol. The battery provides an easy way for its identification information to be provided to (e.g., read by or transmitted to) the aerosol generation device for review and authentication.

In one example, there is provided a method of using an aerosol generation device comprising: obtaining, at an identification module using a wireless communication protocol, identification information from a battery releasably retained in the device; and controlling a function of the aerosol generation device based on the obtained identification information. As described above, these steps improve the safety and/or user experience of the aerosol generation device by preventing batteries that are unsuitable for working with the aerosol generation device to be used.

The method may include the steps of determining that a power loss event has occurred; and determining if the obtained identification information matches identification information of one or more authenticated batteries, scanning for identification information from said battery in the event of a loss of electrical power being detected. In this case, the identification information may be obtained following a battery running out of charge or being removed from the aerosol generation device, which are both indicators that a new battery is going to be installed.

Different combinations of the above referenced features may be combined together in various combinations.

### BRIEF DESCRIPTION OF THE DRAWINGS

Examples of the present disclosure will now be described with reference to the accompanying drawings.

FIG. 1 is a schematic cross-sectional view of an aerosol generation device and an aerosol generation consumable;

FIG. 2A is a schematic cross-sectional view of a battery according to a first example;

FIG. 2B is a schematic cross-sectional view of a battery according to a second example;

FIG. 3 shows a schematic example of an aerosol generation device connected with a telecommunications device over a network;

FIG. 4A shows a schematic example of an aerosol generation device and a battery in a first configuration;

FIG. 4B shows a schematic example of an aerosol generation device and a battery in a second configuration;

FIG. 5 is a flow chart of a method of using an aerosol generation device; and

FIGS. 6A and 6B is a flow chart of a method of authenticating an aerosol generation device.

### DETAILED DESCRIPTION

As used herein, the term “aerosol precursor material”, “vapour precursor material” or “vaporizable material” are used synonymously and refer to a material that releases aerosol when heated. The aerosol precursor material may comprise nicotine and/or tobacco and a vaporising agent. The aerosol precursor material is configured to release an aerosol when heated or otherwise mechanically stimulated (such as by vibrations). Tobacco may take the form of various materials such as shredded tobacco, granulated tobacco, tobacco leaf and/or reconstituted tobacco. Nicotine may be in the form of nicotine salts. Suitable vaporising agents include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin.

An aerosol generation device is configured to aerosolise an aerosol precursor material without combustion in order to facilitate delivery of an aerosol to a user. Furthermore, and as is common in the technical field, the terms “vapour” and “aerosol”, and related terms such as “vaporize”, “volatilize” and “aerosolise”, may generally be used interchangeably.

As used herein, the term “aerosol generation device” is synonymous with “aerosol generating device” or “device”. The device may be portable. “Portable” may refer to the device being for use when held by a user. The device may be adapted to generate a variable amount of aerosol, which can be controlled by a user input.

The aerosol generation device in this case is for use with a removable battery. Given that a user may remove the battery, there is a risk that an incorrect battery may be installed, which may not be compatible with the aerosol generation device. This may pose a safety risk to a user, or lead to a poor technical performance from the aerosol generation device. The use of an identification module, such as an RFID reader, on the device to determine whether the correct battery has been installed would provide an efficient solution for improving safety of the device.

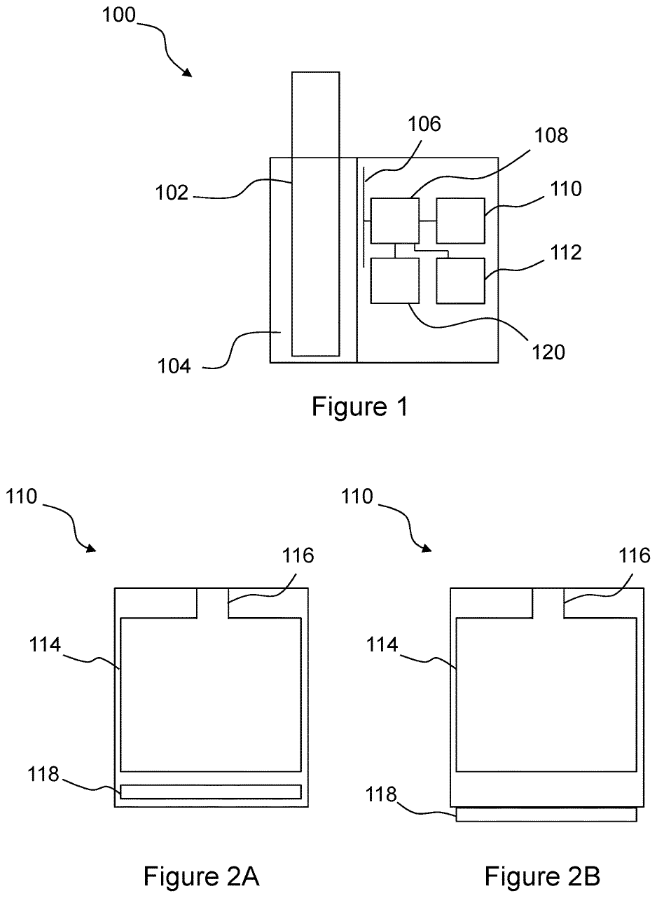

FIG. 1 shows an example of an aerosol generation device 100. In FIG. 1, a solid aerosol generation consumable 102 is shown inserted into a chamber 104 of the aerosol generation device 100, but the aerosol generation device 100 may be configured to work with a liquid and/or gel aerosol generation consumable 102.

The aerosol generation device 100 may include a heater 106 that is configured to generate heat to heat the received aerosol generation consumable 102, in use. In other examples, the aerosol generation device 100 includes other examples for generating aerosol (for example, inductor/susceptor a vibrating unit, electrodes that are configured to apply power directly to a conductive aerosol generation consumable 102, or the like).

The aerosol generation device 100 includes a controller 108 configured to control a function of the aerosol generation device 100. In examples, the controller 108 may be configured to control the heater 106 or the like. For example, the controller 108 may control the amount of power delivered to the heater 106, the timing of the power provided to the heater and/or the heating profile of the heater 106.

The controller 108 may include control circuitry or the like. The controller 108 may receive one or more inputs from various sensors and/or user inputs, such as an input button, puff sensor, aerosol generation consumable detection sensor and control operation of the aerosol generation device 100 based on the one or more inputs.

The aerosol generation device 100 is configured to removably receive a battery 110 to provide electric power. The battery 110 is configured to be electrically coupled with the controller 108 in use. The battery 110 may be a lithium-ion battery or alternative. The battery 110 is configured to be releasably retained within the aerosol generation device 100. That is to say that a user may replace a used batter 110 with a new battery, on occasion.

The aerosol generation device 100 includes an identification module 112 configured to obtain identification information of said battery 110 when releasably retained in the aerosol generation device 100. The identification module 112 is operable to obtain data from the battery 110. For example, the identification module 112 is configured to obtain information that may be used to determine if the battery 110 is authentic or compatible with the aerosol generation device 100.

The identification information of the battery 110 may include one or more of details of the manufacturer, details of the battery type, details of the battery power capacity, details of the battery voltage, serial number of the battery 110 or the like. In other words, the identification information comprises information to indicate whether the battery 110 is suitable for use with the aerosol generation device. In one example, the identification information may include (but is not limited to), one or more of a voltage, capacity, internal resistance, state of charge and depth of discharge.

In one example, the identification module 112 has a separate power source to the battery so is able to continue to operate even when the battery 110 has been removed. For example, the separate power source could be a rechargeable battery. The separate power source could have a rating of 100 mAh or less. If the identification module 112 is powered by a separate power source, then the battery identification check may be performed in such a way to preserve battery life of the separate power source. For example, the battery identification check may be performed at predetermined times. For example, the battery identification check may be performed at intervals of between 2 s and 20 s, or once every 10 s, or once every 5 s. This would preserve battery life of the separate power source. In one example, the separate power source could be recharged even without the main battery 110 being connected.

In other examples, there is not a separate power source for the identification module 112. Instead, the battery 110 would power the identification module 112 only when connected to the aerosol generation device 100. That is to say that the other components of the aerosol generation device 100 would not be powered until the identification check has been completed.

The identification module 112 obtains the identification information wirelessly. That is to say that the identification module 112 operates using a wireless communication protocol. As the identification module operates wirelessly, it can be efficiently located within the aerosol generation device 100, which is limited in space as it is designed to be small and portable. Further, wireless identification avoids potentially harmful wired (electrical) connection between a “non-genuine” (non-safe) battery and the aerosol generation device 100. The wireless aspect also means that it does not need to be in direct contact with the battery 110, in use, which simplifies the aerosol generation device 100. The wireless communication protocol may be Wi-Fi, Bluetooth, Bluetooth mesh, Z-Wave, RFID, cellular, 3G, 4G, 5G, NFC or the like.

The aerosol generation device 100 may include a communication module 120 configured to communication with an external device, such as a communication device. In one example, the communication module 120 is a Bluetooth module, but may be configured to operate using alternatives such as Wi-Fi, Bluetooth mesh, Z-Wave, RFID, cellular, 3G, 4G, 5G, NFC or the like.

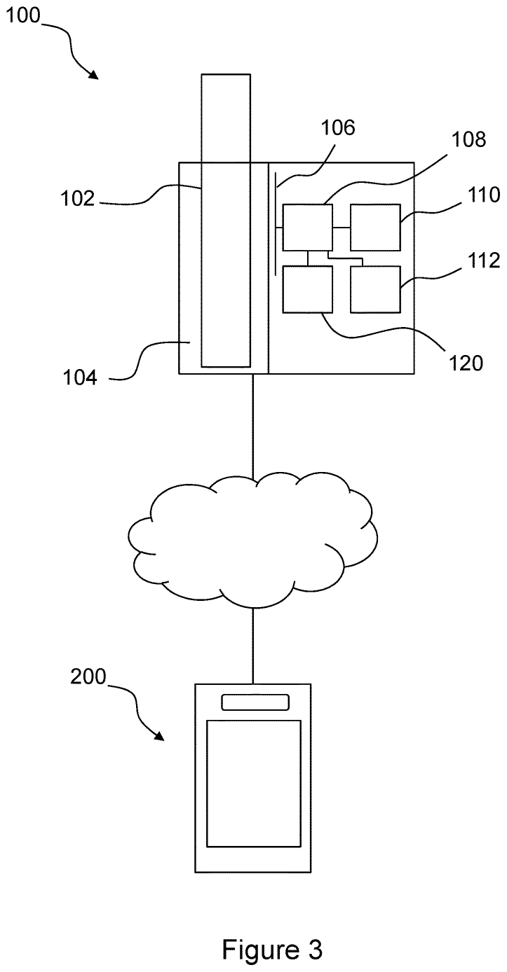

FIG. 2A shows a first schematic example of a battery 110. In this example, the battery 110 comprises a main body 114 and a connector 116. The connector 116 is configured to abut an electric contact of the aerosol generation device 100 in use, so as to transfer electric power from the main body 114 of the battery 110 to the aerosol generation device 100.

The battery 110 may comprise an identification tag 118 (also referred to as an identifier). In FIG. 2A, the identification tag 118 is within a housing of the battery 110, but in the example of the battery 110 shown in FIG. 2B, the identification tag 118 is coupled to an outside of the battery housing. In either example, the identification tag 118 is not coupled with circuitry of the battery 110 itself. Rather, it is a distinct tag that could be easily added to the battery 110 at the end of the manufacturing process.

In one example, the identification tag 118 would be an inlay, such as a thin sticker, that is applied to the inside or outside of the battery housing. In this form, the identification tag 118 would be low cost and can easily be attached to the battery housing.

The identification tag 118 is configured for wireless communication. For example, the identification tag 118 may be a Radio frequency identification (RFID) tag or a Near-field communication (NFC) tag. In some examples, the identification tag 118 is passive, such that it does not require a power supply separate to the of the identification module 112. That is to say that the identification tag utilises power provided by the identification module to operate. For example, if the identification module 112 is an RFID tag, preferably NFC, and utilises the electromagnetic energy transmitted by the identification module in the form of an RFID reader.

The use an identification tag 118 that is coupled with a battery housing means that no additional circuitry or bespoke lines are required within the battery, but rather the identification tag 118 can simply be coupled with the housing of the battery 110 during the manufacturing process (or even afterwards). The identification information may be uploaded to the identification tag 118 in a simple manner.

As the identification tag 118 is decoupled from the circuitry of the battery 110, then it is easy to open up the type of authorised batteries that may be used with the device. For example, the authorised battery need not be tied to a single manufacturer or specification. Instead, an identification tag 118 can simply be added to any battery that is suitable for use with the aerosol generation device 100. This would have benefits when looking to use better performing batteries, obtain lower cost batteries, and the overhead investment. Further, this approach would enable alternate battery specifications to be used and alternate suppliers.

Identification information of the battery 110 is stored on the identification tag 118 and is obtainable by the identification module 112, in use. The identification information may be written on the identification tag 118 during or after production. The identification information allows the battery 110 to be identified and may include information relating to a serial number or the like.

The identification information may be stored separately, for example, in a database or service platform, which may hold a list of authorized batteries for use with the aerosol generation device 100. New authorised batteries that are made may be added to the database or service platform (or perhaps include some information which would indicate that they are authentic).

In other examples, the identification information may comprise details of characteristics of the battery 110. For example, the identification information may comprise a power rating or voltage rating of the battery 110. The identification information may comprise details of the make-up of the battery, for example the type of battery 110 or the chemistry associated with the battery 110.

In some examples, the identification information is unique to the battery, but the identification information may also apply to a batch of batteries.

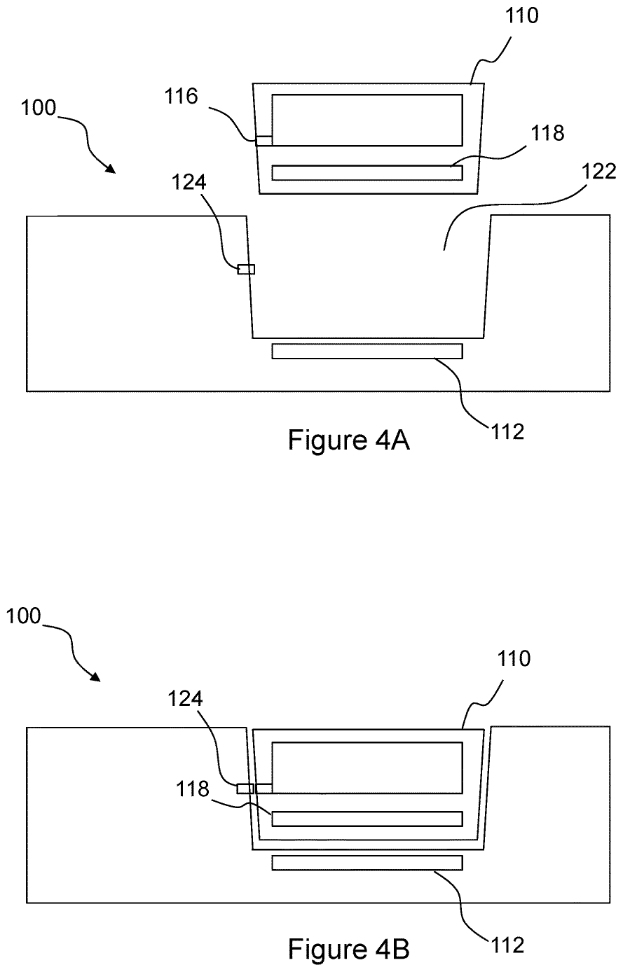

FIG. 3 shows a schematic diagram of the aerosol generation device 100 in communicative contact with a communication device 200. The communication device 200 may be any device capable of receiving/transmitting information from/to the aerosol generation device 100. For example, communication device 200 may include a communication module, such as a Bluetooth module that is configured to couple with an equivalent Bluetooth module of the aerosol generation device 100. Other types of communication module may be implemented in the communication device 200 (e.g., RFID, NFC, etc.).

In one example, a check of whether the installed battery is authentic may be initiated by a user of the communication device 200. For example, a user may open an application/software relating to the aerosol generation device 100 and instruct the application/software to run a battery identification check. The battery identification check comprises the step of the identification module 112 obtaining (or attempting to obtain) identification information of the battery 100. For example, the identification module 112 may obtain identification information from the identification tag 118 of the battery 100.

The aerosol generation device 100 may then communicate the obtained identification information with the communication device 200, for example by using the communication module 120. The communication device 200 may then verify if the obtained identification information is authentic, for example, by comparing the obtained identification information against a database or platform of identification information of authorised batteries and then communicate to the aerosol generation device 100 that the battery 110 is suitable for use (or not suitable for use depending on the result).

In some examples, the communication device 200 stores the database of authentic identification information locally, but in other examples, the database is stored externally and the communication device 200 transmits the obtained identification information to be verified externally.

In some examples, the aerosol generation device 100 may perform the authentication locally. That is to say that the aerosol generation device 100 may include a memory configured to store identification information of one or more authenticated batteries and the controller 108 is configured to determine if the received identification information matches identification information of an authenticated battery. The aerosol generation device 100 may receive identification information of one or more authenticated batteries via a communication module of the aerosol generation device 100.

The identification information of the battery 110 may be updated through a connection with an external device, such as a communication device. This could be achieved in a similar way as firmware update through connection.

In one example, the function controlled by the controller 108 relates to the provision of electrical power to a main circuit board of the aerosol generation device 100. For example, if it is detected that the battery 110 is not authentic (or designed for use with the aerosol generation device 100), then the electric power from the battery 110 is prevented from powering the main circuit board of the aerosol generation device 100. The aim of this would be to prevent damage to the main circuit board from receiving electric power from a battery 110 that may not be designed for use with the aerosol generation device 100. For example, the unauthentic battery may have a higher power rating than the circuit board is designed to receive and so the circuit board would be damaged if it received electric power from the unauthentic battery.

In other examples, the function controlled by the controller relates to the provision of electric power to the heater 106 of the aerosol generation device 100. For example, the heater 106 is prevented from heating up and so little (or no) aerosol will be generated.

In some examples, the controller 108 is configured to operate the aerosol generation device 100 in different modes based on the obtained identification information of the battery 110. That is to say that the aerosol generation device 100 may operate in a first mode and a second mode and the first mode or second mode is selected based on a characteristic of the battery. The characteristic of the battery may be present in or derivable from the obtained identification information. The first mode may relate to the heater providing heat at a first temperature and the second mode may relate to a heater providing heat at a second temperature. In one example, power management of the aerosol generation device 100 may be controlled based on the identification information. For example, if the identification information indicates that if the battery has a first characteristic (e.g., a first voltage rating), then the controller 108 is configured to operate the heater 106 to heat the aerosol generation consumable 102 to a first temperature. Further, if the identification information indicates that if a battery 110 instead has a second characteristic (e.g., a second voltage rating), then the controller 108 is configured to operate the heater 106 to heat the aerosol generation consumable 102 to a second temperature. The same may be true for heating profiles, or the like. That is to say that if the identification information indicates that if the battery 110 has a first characteristic, then a first heating profile is used and if the identification information indicates that if the battery has a second characteristic, then a second heating profile is applied. In this case, the aerosol generation device 100 may be configured to operate optimally depending on a characteristic of the battery 110 that has been inserted into the aerosol generation device 100.

In this example, the controller may change the operating conditions of the aerosol generation device 100 based on characteristics of the battery 100 that is powering it. The identification information of the battery 100 can be updated accordingly for power management. The identification information could be, for example, a power requirement on current, voltage, state of health (SOH) of battery, or other measurable battery characteristics. In this case, any battery passing safety check can be an authenticated battery, enabled for use.

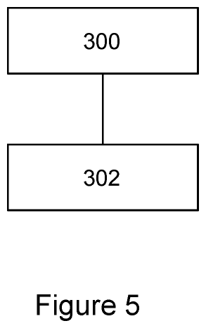

FIG. 4A shows a highly schematic example of an aerosol generation device 100 and battery 110. In FIG. 4A, the battery 110 is located outside of the aerosol generation device.

FIG. 4A shows that the battery 110 may have an asymmetric battery housing that is configured to fit within a correspondingly shaped recess 122 of the aerosol generation device 100. In other words, regular shaped batteries may not fit within the recess of the aerosol generation device 100. In the example shown in FIG. 4A, the battery 110 has a substantially trapezium shape, but other asymmetric shapes are envisaged.

In some examples, the connector 116 of the battery is offset from a central axis of the battery 110. This would prevent power being supplied from the battery 110 in the event of the battery 110 being installed incorrectly. The connector 116 is configured to electrically connect with a terminal 124 of the aerosol generation device when the battery 110 is correctly installed.

FIG. 4B shows a highly schematic system including the aerosol generation device 100 and the battery 110. In this example, the battery 110 is asymmetric and is received in a correspondingly asymmetric shaped recess of the aerosol generation device 100. In some examples, the battery 110 has an irregular shape and the recess has a corresponding irregular shape.

As can be seen from FIG. 4B, the identification module 112 may be located in the aerosol generation device 100 such that it is adjacent to (or close to) the recess in which the battery 110 is configured to be received. That is to say that the identification module 112 may be substantially aligned with the with the identification tag 118, in use, to obtain identification information from the identification tag.

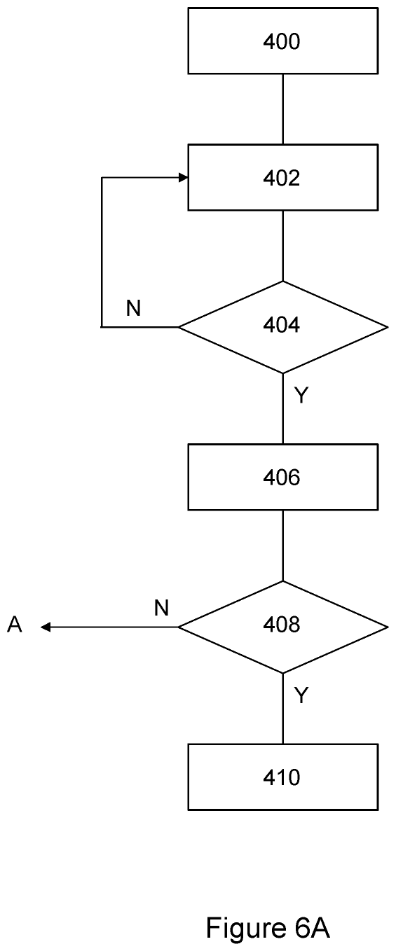

FIG. 5 shows a flow chart of a method of using the aerosol generation device 100. At step 300, there is a step of obtaining, at the identification module 112 using a wireless communication protocol, identification information from a battery 110 releasably retained in the device 100.

At step 302, there is a step of controlling a function of the aerosol generation device 100 based on the obtained identification information.

In some examples, the step of obtaining the identification information occurs in response to the battery 110 being detected in the aerosol generation device 100. For example, the aerosol generation device 100 may detect that there is a battery 110 attempting to supply power or there may be a battery detector within the device that senses when a battery 110 has been installed.

In some examples, the step of obtaining information occurs in response to a power loss event. The power loss event could be the result of a previous battery being removed from the aerosol generation device 100. As such, when a new battery is installed, the aerosol generation device 100 then runs a new battery identification check to determine if the newly installed battery is suitable for use with the aerosol generation device. In one example, the identification module is configured to scan for identification information from a battery 110 in the event of a loss of electrical power being detected. That is to say that following a power loss event, a battery identification check may be performed before the aerosol generation device 100 can be used to generate aerosol from the aerosol generation consumable 102.

In some examples, after the battery identification check has been performed and the battery 110 has been determined to be suitable for use with the aerosol generation device 100, the identification information of the installed battery 110 is saved to a memory of the aerosol generation device 100. This means that future battery identification checks of this battery 110 may be performed locally on the device and so may be run in the background and a user may not even be aware that it is occurring. This allows for any future power loss event due to battery being fully discharged to simply check the battery identification information stored on the device and allow full functionality if a match is found, without the need of pairing to a communication device, opening the product application and checking the service platform. In the case of a battery discharge, this process may happen without the user being aware.

In other situations in which a new battery 110 has been installed, a user may need to connect the aerosol generation device 100 with a communication device 200 (as described above and in FIG. 3) and either transmit the obtained identification information to the communication device 200 to determine whether the identification information of the new battery 110 matches with an authorised battery, or receive an updated list of authentic battery identification information and perform the check locally.

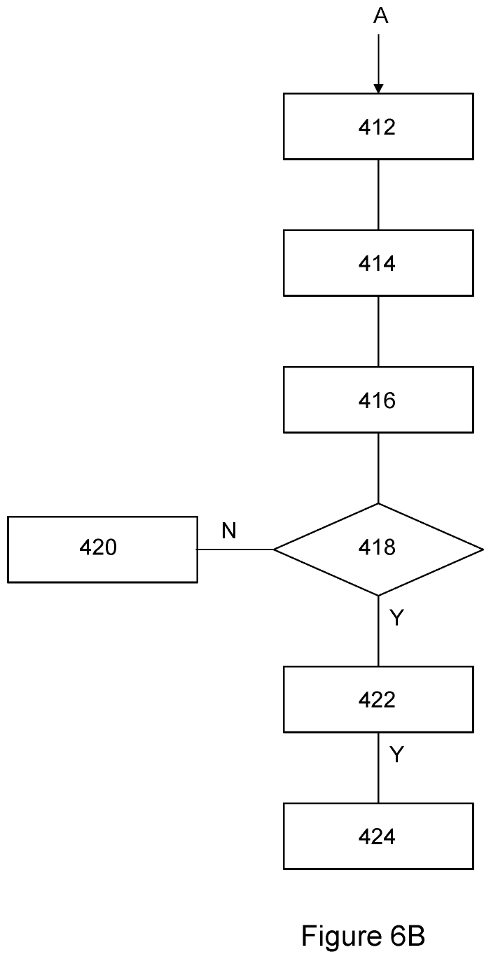

FIGS. 6A and 6B show an example of a battery identification check of the aerosol generation device 100. At step 400 a power loss event is detected, which may initiate the battery identification check process. At step 402, the identification module 112 of the device attempts to obtain identification information from a battery 110. As step 404, if no information is obtained (e.g., if the battery is not present or has zero charge), then the aerosol generation device functionality is locked and the identification module 112 will re-attempt to obtain identification information of the battery 110. If identification information is obtained, then at step 406 the controller 108 checks the obtained identification information against locally stored approved (or authentic) battery identification information in a memory of the aerosol generation device 100. At step 408, if the obtained identification information matches approved battery identification information, then the controller 108 controls a functionality of the aerosol generation device 100. For example, it may enable power to be supplied to the main circuit board of the aerosol generation device 100.

If the obtained identification information does not match locally stored approved (or authentic) battery identification information, then at step 412, the aerosol generation device 100 is configured to communication with a communication device 200. At step 414, a user may open an application on the communication device 200. The obtained identification information is transmitted to the communication device 200. At step 416, the application on the communication device 200 checks the obtained identification information of the battery against a service platform.

At step 418, if it is determined that the obtained battery information matches approved battery identification information then approval data is transmitted to the aerosol generation device at step 422 and the controller 108 controls a functionality of the aerosol generation device 100. For example, it may enable power to be supplied to the main circuit board of the aerosol generation device 100.

At step 424, the identification information of the verified battery 110 is stored locally on the aerosol generation device 100.

If at step 418, it has been determined that the obtained battery information does not match approved identification information then the aerosol generation device 100 is prevented from functioning. That is to say that power from the battery 110 may not be provided to the main circuit board of the aerosol generation device 100.

Although preferred embodiments have been shown and described, it will be appreciated by those skilled in the art that various changes and modifications might be made without departing from the scope of the invention, as defined in the appended claims and as described above.

1. An aerosol generation device for releasably retaining a battery, the aerosol generation device comprising:
an identification module configured to obtain identification information of said battery when releasably retained in the device; and
a controller configured to control a function of the aerosol generation device based on the received identification information,
wherein the identification module is configured to obtain the identification information from the battery using a wireless communication protocol, and
wherein the identification module is configured to scan for identification information from said battery in the event of a loss of electrical power from the battery being detected.

2. The aerosol generation device of claim 1, wherein the event of the loss of electrical power from the battery comprises:
removal of the battery from the aerosol generation device; or
the battery losing all of the electric charge.

3. The aerosol generation device according to claim 1, wherein the identification module is configured to receive the identification information from said battery.

4. The aerosol generation device according to any one of claim 1, wherein the identification module comprises a radio frequency identification module.

5. The aerosol generation device according to claim 4, wherein the radio-frequency identification module comprises a Near Field Communication module.

6. The aerosol generation device according to claim 1, wherein the function comprises providing electrical power to a main circuit board of the aerosol generation device.

7. The aerosol generation device according to claim 1, wherein the aerosol generation device comprises a memory configured to store identification information of one or more authenticated batteries,
wherein, the controller is configured to determine if the received identification information matches identification information of an authenticated battery.

8. The aerosol generation device according to claim 7, wherein the aerosol generation device further comprises a communication module configured to receive identification information of one or more authenticated batteries.

9. The aerosol generation device according to claim 1, wherein the identification information includes information on a characteristic of said battery and the controller is configured to provide a power output level dependent on the characteristic.

10. A system comprising:
the aerosol generation device according to claim 1; and
a battery releasably retained in the aerosol generation device.

11. The system according to claim 10, wherein the battery comprises an identification tag, wherein the identification module is configured to be substantially aligned with the identification tag, in use, to obtain identification information from the identification tag.

12. The system according to any one of claim 10, wherein the battery is an asymmetrical shape configured to be releasably received in a corresponding matching asymmetrical recess in the aerosol generation device.

13. A method of using an aerosol generation device comprising:
obtaining, at an identification module using a wireless communication protocol, identification information from a battery releasably retained in the device;
controlling a function of the aerosol generation device based on the obtained identification information; and
scanning for identification information from said battery in the event of a loss of electrical power from the battery being detected.

14. The method according to claim 13, wherein the event of the loss of electrical power from the battery comprises:
removal of the battery from the aerosol generation device; or
the battery losing all electric charge.

15. The method according to claim 13, comprising:
determining that a power loss event has occurred; and
determining if the obtained identification information matches identification information of one or more authenticated batteries.

16. The aerosol generation device according to claim 2, wherein the identification module is configured to receive the identification information from said battery.

17. The aerosol generation device according to claim 2, wherein the identification module comprises a radio frequency identification module.

18. The aerosol generation device according to claim 3, wherein the identification module comprises a radio frequency identification module.

19. The method according to claim 14, comprising:
determining that a power loss event has occurred; and
determining if the obtained identification information matches identification information of one or more authenticated batteries.
